(19) United States
(12) Patent Application Publication
(10) Pub. No.: US 2011/0210203 A1
(43) Pub. Date: Sep. 1, 2011

(54) GALLEY UNIT

(75) Inventors: Tien Shyang Timothy Chua, Singapore (SG); Fook Ping Chen, Singapore (SG); Ee-Lin Gina Goh, Singapore (SG); Check Kan Foo, Singapore (SG)

(73) Assignee: SINGAPORE AIRLINES LIMITED, Singapore (SG)

(21) Appl. No.: 13/060,228

(22) PCT Filed: Aug. 22, 2008
(86) PCT No.: PCT/SG2008/000310

§ 371 Date: May 19, 2011

(51) Int. Cl. B64D 11/04; A47B 46/00

(52) U.S. Cl. 244/118.5

(57) ABSTRACT

A multi-functional galley unit suitable for aircraft is disclosed. The galley unit includes two display compartments for food and other items (such as glasses) positioned above a bench top. Each display compartment comprises a main section in the form of a rear cabinet and a front door that can be swung between a closed orientation for storing items and an opened orientation in which the items are displayed and passengers can select and remove items from the compartments as desired. When the doors are in the closed position, cabin crew have full access to the bench top to assist in the preparation and serving of meals.

### FIELD OF THE PRESENT INVENTION

The present invention relates to a galley unit suitable for use in vehicles such as trains, ships, and is particularly suited for aircraft.

### BACKGROUND OF THE PRESENT INVENTION

Cabin space on board aircraft is limited and at a premium. In terms of providing catering services, compact ovens, refrigerators and tray storage devices have been devised for use by crew on board aircraft to service passengers. Consequently, galley areas are compact and very functionally oriented to providing meals services.

During long flights, passengers often have an opportunity to leave their designated seats between scheduled meals. It is particularly the case on long flights that passengers want to have access to snacks and drinks on a self-serve basis.

It is object of the present invention to provide a galley unit that serves two functions, namely as a servery for use by crew members during meal service periods and as a facility that passengers can utilise unassisted during periods of a flight between scheduled meals.

### SUMMARY OF THE INVENTION

According to the present invention there is provided an aircraft galley unit for use by crew members during meal service periods and for use by passengers during other periods during the course of a flight including:

an upwardly facing work surface;

at least one display compartment suitable for containing items of food and other items positioned above the work surface for access by passengers, the compartment having a closed orientation in which the items in the compartment are safely stored in the compartment and are not accessible and an opened orientation in which the items are on display and can be selected by passengers from the compartment as desired.

The above described galley unit, by virtue of the compartment or compartments having closed and opened orientations, makes it possible to optimise the available space in an aircraft galley for use by cabin crew during a meal service period and by passengers during other periods. In particular, the galley unit provides an opportunity for airlines to have a dedicated high quality area for displaying food items and other items, such as glasses, so that passengers can have snacks and drinks between meal times. At present, where such snacks are provided by airlines, this is almost as an afterthought and is not satisfactory.

Preferably the galley unit includes latches or other suitable members that can secure the compartment or compartments in the opened and the closed orientations.

Although the galley unit may include any number of the compartments that may be the same size or of varying sizes, preferably the galley unit includes a pair of the compartments that are suitably substantially equal size and spaced apart compartments positioned on or above opposite ends of the work surface.

In a situation in which the galley unit comprises two compartments, the compartments may be converted from the closed to the opened orientations by swinging a front portion of each compartment outwardly and toward the other compartment and against a back wall of the galley unit in the space between the compartments and thereby allow access to the compartments.

Typically each compartment is in a form of a cabinet having a main section located in a fixed position on or above the work surface and a door that is pivotally mounted to the main section. With this arrangement, typically the doors are hung so that the doors can be swung outwardly and then toward each other and against the back wall of the galley unit between the compartments.

Preferably the main section and the door of each compartment include shelving on which food items and other items, such as glasses can be placed. This arrangement provides an opportunity for the sizes of the main section and the door of each compartment and the length of the work surface to be selected so that food and other items are on display on the back wall of the galley unit at least substantially along the whole of the length of the work surface when the compartments are in the opened position.

Depending on the nature of the food and other items, the height or spacing of the shelving in the main section and the door are adjustable. For example, the shelves can be spaced to receive tall cans or bottles of the beverages, or relatively flat items such as individually packaged biscuits.

The adjustability may be provided by any suitable supports including a series of slots in which the shelving is received or locking pins that are receive by one of a series of holes formed in the cabinet or the door.

The shelving of the main section and the door of each compartment may have co-operating leading edges in the form of curved profiles that provide the galley unit with a pleasing appearance when the cabinets are in the opened orientation. In the case of the main section, suitably the leading edge includes a concave profile and in the case of the door, suitably the leading edge includes a complementary convex profile. In a situation in which the shelving of the main section and the door are at corresponding heights, the profiles of the shelving of the cabinet and door inter-fit.

Preferably the main section of the cabinet includes two side walls and a back wall, and the door is an L-shape formation with front and side panels arranged in the shape of an “L” with the side panel pivotally connected to one of the side walls of the main section.

Preferably when the door is closed so that the compartment is in the closed orientation, the side panel of the door is substantially parallel, and suitably co-planar, with the side wall of the main section to which it is pivotally connected.

Preferably when the door is fully opened in the opened orientation, the front panel is substantially parallel, and suitably co-planar, with the back wall of the main section.

The compartments may be spaced above the work surface. However, preferably the compartments are on the work surface.

The work surface may be made of any material, suitably a lightweight material including laminate material, imitation granite, marble or stone type products.

The work surface may also include other utilities such as a sink, water taps or an opening into a waste disposal bin.

In more general terms the present invention provides a galley unit for use by staff members during meal service periods and by other persons during other periods including:

an upwardly facing work surface;

at least one display compartment suitable for containing items of food and other items positioned above the work surface, the compartment having a closed orientation in which the items in the compartment are safely stored in the compartment and are not accessible and an opened orientation in which the items are on display and can be selected from the compartment as desired.

The above-described galley unit is particularly suitable for use in aircraft (as mentioned above) and in other vehicles such as trains.

The galley unit may include any one or more of the above-described features of the aircraft galley unit.

### BRIEF DESCRIPTION OF THE DRAWINGS

An embodiment of the present invention will now be described with reference to the accompanying figures, of which:

FIG. 1 is perspective view of the embodiment in the form of an aircraft galley, wherein the galley unit includes a pair of display compartments each having openable doors that are located in a closed position;

FIG. 2 is perspective view of the galley unit shown in FIG. 1 with the doors of the display compartments in an open position; and

FIG. 3 is a cross-sectional view along the line A-A of the galley unit shown in FIG. 1, wherein the location of the doors of the display compartments are shown by the solid lines when in the closed position and are shown in dashed lines when being moved from the closed position to an open position in the direction of the arrows.

### DETAILED DESCRIPTION

The present invention is now described with reference to the aircraft galley unit shown in the Figures. The galley unit is suitable for use in any other situation in which catering is required and is particularly well adapted for applications in which the space available is restricted, as is the case in aircraft and, for example, in trains and ships.

With reference to the Figures, the galley unit is a multi-functional unit that cabin crew can readily change from one configuration to another configuration depending on the particular circumstances. One configuration is as a servery for cabin crew to use to prepare and serve meals for passengers and the other configuration is a recreational unit for passengers to use between meal times as a source of well-presented snacks and drinks.

The galley unit comprises: i) a bench top 11 made of any suitable material such as imitation marble or stone that defines an upwardly facing work surface, ii) a pair of equal sized display compartments 10 that are spaced apart and disposed at opposite ends of the galley above the bench top 11, and iii) a set of storage compartments 12 located below the bench top 11 that are adapted for receiving conventional carts carrying passenger trays that are wheeled along the walkway of aircraft.

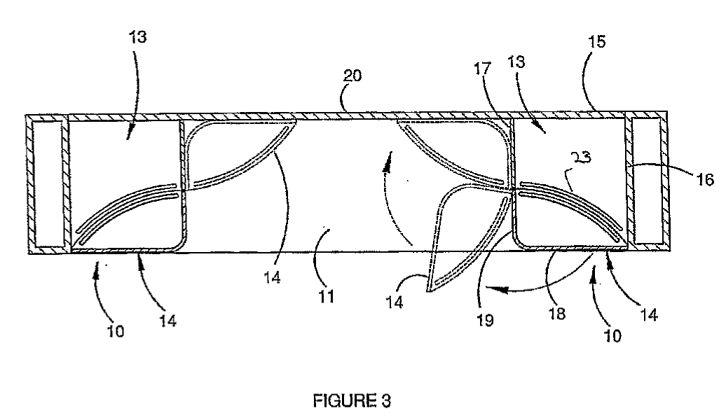

As can best be seen in FIG. 3, each display compartment 10 comprises (a) a rear cabinet 13 that is fixed in position on the bench top 11 and forms a main section of the compartment and (b) a forward moveable cabinet that in essence is a specifically adapted L-shaped door 14 that is pivotally connected to the rear cabinet 13 by way of any suitable hinged mechanism.

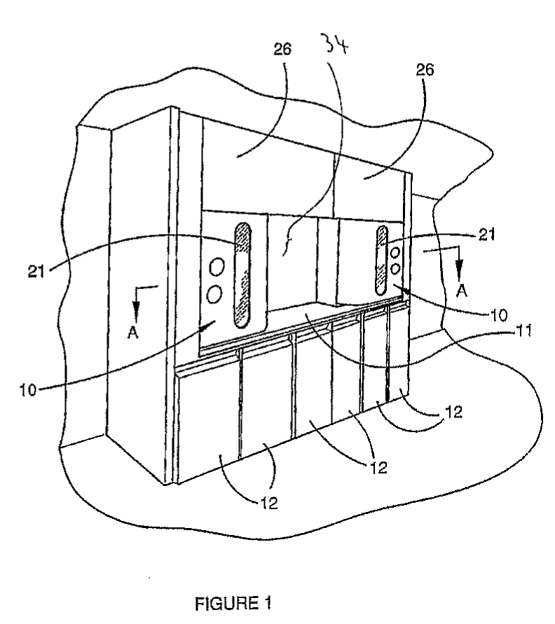

In a situation in which cabin crew are serving meals to passengers at designated meal periods with the passengers in their seats, the doors 14 are located in a closed orientation as shown in FIG. 1 to safely store the items in the compartments 10 and to thereby isolate the items during use of the galley unit as a servery during the meal times and to maximise the useable surface of the bench top 11 between the compartments 10. The doors are also kept in the closed orientation during periods of turbulence when free movement of passengers around the aircraft is suspended.

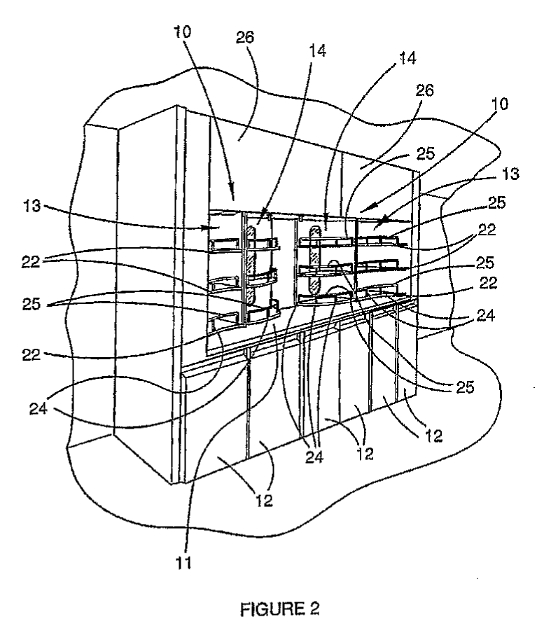

Once the meals have been served and the meal trays are returned to the cabin crew and the carts are stowed away in the storage compartments 12 beneath the bench 11 and when passengers are able to move around the aircraft, the doors 14 of the display compartments 10 can then be swung open against a back wall 34 of the galley unit between the compartments to form a display for the items in the compartments that, in the case of the embodiment shown in the Figures, extends substantially across the entire width of the galley unit, as shown in FIG. 2. This is a significant and very presentable display of the items. Moreover, the configuration allows passengers an opportunity to identify and select items on display in a very convenient way. In particular, this configuration provides bench top space in front of the opened display compartments 10, which is convenient for passengers wishing to place glasses or plates (which may be stored in the compartments) on the bench top 11 in front of locations of the display from which the passengers intend to remove food items from the compartments.

The spacing of the display compartments 10 and, thus, the width of the bench top 11 between the compartments 10 is typically in a range of 800 to 1200 mm, and even more suitably approximately 1050 mm. This spacing enables two or more meal trays to be placed on the bench-top 11 when the doors 14 are located in the closed orientation.

The back wall 34 of the galley unit includes a mirror that improves the aesthetic appearance of the galley unit, particularly when the display compartments 10 are in the closed orientation.

The rear cabinet 13 of each display compartment 10 comprises a rear wall 15 and two side walls 16 and 17 that extend outwardly from the rear wall 15. The side walls are in the form of an outer side wall 16 located toward the outer extremities of the galley and an inner side wall 17 that faces toward the bench top 11 and the respective inner side wall 17 of the other compartment 10. The L-shaped door 14 comprises a front panel 18 and a side panel 19, wherein the side panel 19 is pivotally connected to the inner side wall 17 of the cabinets. When the door is located in the closed orientation as shown in FIG. 1, the inner side wall 17 of the cabinet 13 and the side panel 19 of the door are co-planar. In a situation in which the door is located in the fully opened orientation, the side panel 19 of the door abuts against the outer face of the inner side wall 17 of the cabinet 13 and the front panel 18 of the door aligns with the rear wall or splash back 20 of the galley unit.

The front panel 18 of the door 14 of each display compartment 10 also includes a viewing window 21 which enables crew to check whether breakable items such as glasses in the compartment are intact when the door is located in the closed orientation shown in FIG. 1 prior to opening the door. This is an important safety feature, particularly after periods of turbulence.

The cabinets 13 and the doors 14 of each display compartment 10 include shelving 22, suitably two or more shelves and suitably three shelves spaced one above the other over a total height of 500 to 600 mm. Although the shelves 20 of the cabinet 13 and the door 14 may be located at any height to enable the shelves to cater for the any desired items, including magazines, books or other recreation items, preferably the shelves on the rear cabinet 13 and the door formation 14 are located at any corresponding heights as shown in FIGS. 1 and 2 and are adapted for receiving any food items such as pre-packaged cans of drink, packets of chips, biscuits, peanuts, health food bars and unpackaged foods items such as bananas, apples and oranges, and other items such as glasses and crockery. A leading edge 23 of each shelf 22 includes co-operating curved profiles which when the shelves are mounted at corresponding heights as in FIGS. 1 and 2, inter-fit. As can be seen in the FIGS. 2 and 3, the sculptured profiles of the shelving 22 are preferably in the form of a concave profile in the cabinets 13 and in the form of a corresponding convex profile in the doors 14.

A barrier on the shelving 22 comprising posts 24 and a railings 25 extending between the posts 24 is designed to the prevent foods items and breakable items such as glasses from inadvertently falling from the shelving 22.

The display compartments 10 also include suitable lighting that is actuated automatically when the compartments are moved to the opened orientations. The lighting facilitates selection of the items by passengers and contributes to the visual impression created by the galley unit.

Although not shown in detail of the Figures, the galley unit includes a locking device for locking the doors 14 in the opened and closed orientations. The locking device is in the form, but by no means limited to, any one or a combination of the following mechanisms, a retractable locking pin and recess, the latching mechanism, co-operating magnetised portions or inter-fitting friction clip.

Additional storage compartments 26 are located above the display compartments 10 and contain desired materials including additional food items and other machinery or equipment items such as life jackets relating to the operation or safety of the aircraft. The additional compartments have down lighting installed to emit light onto the bench top 11.

Those skilled in the art of the present invention will appreciate that may modifications and variations may be made to the embodiment described above without departing from the spirit and scope of the present invention.

The claims defining the invention are as follows:

1. A aircraft galley unit for use by crew members during meal service periods and for use by passengers during other periods during the course of a flight including:
an upwardly facing work surface;
at least one display compartment suitable for containing items of food and other items positioned above the work surface for access by passengers, the compartment having a closed orientation in which the items in the compartment are safely stored in the compartment and are not accessible and an opened orientation in which the items are on display and can be selected by passengers from the compartment as desired.

2. The galley unit defined in claim 1 includes a pair of the compartments that are substantially equal site and are spaced apart on or above opposite ends of the work surface.

3. The galley unit defined in claim 2 wherein the compartments are adapted to be converted from the closed to the opened orientations by swinging a front portion of each compartment outwardly and toward the other compartment and against a back wall of the galley unit in the space between the compartments to thereby allow access to the compartments.

4. The galley unit defined in claim 3 wherein each compartment is in a form of a cabinet having a main section located in a fixed position on or above the work surface and a door that is pivotally mounted to the main section, and the doors are hung so that the doors can be swung outwardly and then toward each other and against the back wall of the galley unit between the compartments.

5. The galley unit defined in claim 4 wherein the main section and the door include shelving on which food items and other items, such as glasses can be placed so as to provides an opportunity for food and other items to be displayed on the back wall of the galley unit at least substantially along the whole of the length of the work surface.

6. The galley unit defined in claim 4 or claim 5 wherein the height or spacing of the shelving in the main section and the door are adjustable.

7. The galley unit defined in claim 6 wherein the adjustability is provided by supports including a series of slots in which the shelving is received or locking pins that are receive by one of a series of holes formed in the cabinet or the door.

8. The galley unit defined in any one of claims 4 to 7 wherein the shelving of the main section and the door have co-operating leading edges in the form of curved profiles that provide the galley unit with a pleasing appearance when the cabinets are in the opened orientation.

9. The galley unit defined in claim 8 wherein, in the case of the main section, the leading edge includes a concave profile and in the case of the door, the leading edge includes a complementary convex profile.

10. The galley unit defined in any one of claims 4 to 9 wherein the main section of the cabinet includes two side walls and a back wall, and the door is an L-shape formation with front and side panels arranged in the shape of an “L” with the side panel pivotally connected to one of the side walls of the main section.

11. The galley unit defined in claim 10 wherein, when the door is closed, the side panel of the door is substantially parallel with the side wall of the main section to which it is pivotally connected.

12. The galley unit defined in claim 10 or claim 11 wherein, when the door is fully opened in the opened orientation, the front panel is substantially parallel with the back wall of the main section.

13. The galley unit defined in any one of the preceding claims wherein the compartments are on the work surface.

14. A aircraft galley unit for use by crew members during meal service periods and for use by passengers during other periods during the course of a flight including:
an upwardly facing work surface;
a pair of display compartments suitable for containing items of food and other items positioned on or above the work surface for access by passengers, each compartment having a closed orientation in which the items in the compartment are safely stored in the compartment and are not accessible and an opened orientation in which the items are on display and can be selected by passengers from the compartment as desired, the compartments being substantially equal size and spaced apart on or above opposite ends of the work surface, each compartment being in a form of a cabinet having a main section located in a fixed position on or above the work surface and a door that is pivotally mounted to the main section, with the doors of the compartments being hung so that the doors can be swung outwardly from the closed orientation of the compartments and then toward each other and against the back wall of the galley unit between the compartments into the opened orientation of the compartments.

15. The galley unit defined in claim 14 wherein the main section of each cabinet includes two side walls and a back wall, and the door is an L-shape formation with front and side panels arranged in the shape of an “L” with the side panel pivotally connected to one of the side walls of the main section.

16. The galley unit defined in claim 15 wherein, when the door of each cabinet is closed, the side panel of the door is substantially parallel with the side wall of the main section to which it is pivotally connected.

17. The galley unit defined in claim 15 or claim 16 wherein, when the door of each cabinet is fully opened in the opened orientation of the compartment, the front panel is substantially parallel with the back wall of the main section.
